(19) United States
(12) Patent Application Publication
(10) Pub. No.: US 2014/0320584 A1
(43) Pub. Date: Oct. 30, 2014

(54) DISPLAY DATA TRANSMISSION TO AN EXTERNAL DISPLAY OF A DATA PROCESSING DEVICE TO ENHANCE A VIDEO PHONE CALL EXPERIENCE THERETHROUGH

(71) Applicant: NVIDIA Corporation, Santa Clara, CA (US)

(72) Inventor: Abhishek Kumar, Bokaro Steel City, Jharkhand (IN)

(73) Assignee: NVIDIA Corporation, Santa Clara, CA (US)

(21) Appl. No.: 13/872,074

(22) Filed: Apr. 27, 2013

(51) Int. Cl. H04N 7/14

(52) U.S. Cl. CPC H04N 7/147
USPC 348/14.03; 348/14.04

(57) ABSTRACT

A method to enhance a video call experience on a data processing device includes detecting, through a processor of the data processing device communicatively coupled to a memory, an incoming video phone call thereto. The method also includes transmitting, through the processor, display data associated with a display of the data processing device to a target display to be rendered thereon upon the detection of the incoming video phone call. The target display is external to the data processing device and communicatively coupled thereto.

### FIELD OF TECHNOLOGY

This disclosure relates generally to data processing devices and, more particularly, to a method, a device and/or a system of display data transmission to an external display of a data processing device to enhance a video phone call experience therethrough.

### BACKGROUND

A user of a data processing device (e.g., a mobile phone) may utilize a display thereof during a video phone call. The display of the data processing device may be inappropriate for rendering video stream data associated with the video phone call. The inappropriateness may be due to a small size of the display, a low resolution thereof and the like. The inappropriateness of the display may provide for a frustrating video call experience to the user.

### SUMMARY

Disclosed are a method, a device and/or a system of display data transmission to an external display of a data processing device to enhance a video phone call experience therethrough.

In one aspect, a method to enhance a video call experience on a data processing device is disclosed. The method includes detecting, through a processor of the data processing device communicatively coupled to a memory, an incoming video phone call thereto. The method also includes transmitting, through the processor, display data associated with a display of the data processing device to a target display to be rendered thereon upon the detection of the incoming video phone call. The target display is external to the data processing device and communicatively coupled thereto.

In another aspect, a non-transitory medium, readable through a data processing device and including instructions embodied therein that are executable through the data processing device, is disclosed. The non-transitory medium includes instructions to detect, through a processor of the data processing device communicatively coupled to a memory, an incoming video phone call thereto. The non-transitory medium also includes instructions to transmit, through the processor, display data associated with a display of the data processing device to a target display to be rendered thereon upon the detection of the incoming video phone call. The target display is external to the data processing device and communicatively coupled thereto.

In yet another aspect, a system includes a data processing device including a memory, a processor communicatively coupled to the memory and a display, and a target display external to the data processing device and configured to be communicatively coupled thereto. The processor of the data processing device is configured to execute instructions to detect an incoming video phone call thereto and to transmit display data associated with the display of the data processing device to the target display to be rendered thereon upon the detection of the incoming video phone call.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data processing device capable of transmitting display data associated with a video phone call to a target display, according to one or more embodiments.

FIG. 2 is a schematic view of interaction between a driver component and a processor of the data processing device of FIG. 1, according to one or more embodiments.

FIG. 3 is a schematic view of a user interface of the data processing device of FIG. 1, according to one or more embodiments.

FIG. 4 is a process flow diagram detailing the operations involved in display data transmission to the target display of the data processing device of FIG. 1 to enhance a video phone call experience therethrough, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of display data transmission to an external display of a data processing device to enhance a video phone call experience therethrough. Although the present embodiments have been described with reference to specific example embodiments, it will be evident that various modifications and changes may be made to these embodiments without departing from the broader spirit and scope of the various embodiments.

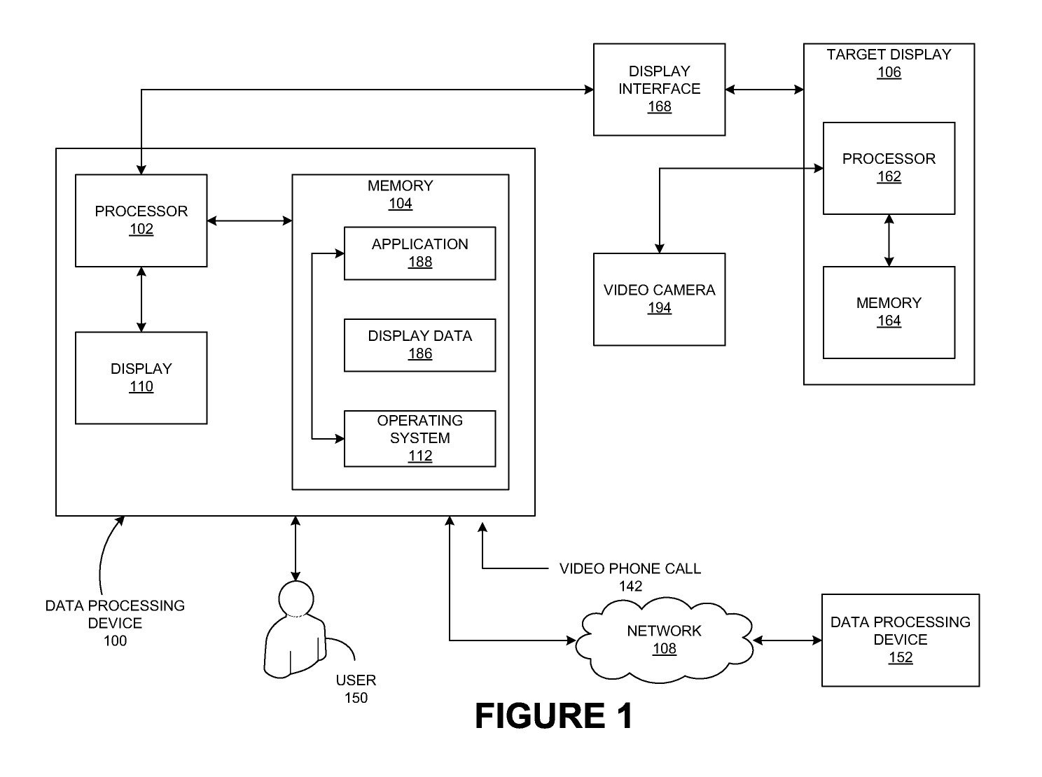

FIG. 1 shows a data processing device 100 capable of transmitting display data associated with a video phone call 142 to a target display 106 (e.g., a Liquid Crystal Display (LCD), a Cathode Ray Tube (CRT) monitor), according to one or more embodiments. In one or more embodiments, data processing device 100 may be a mobile device such as a mobile phone or a tablet computer. Other forms of data processing device 100 capable of receiving video phone call 142 are within the scope of the exemplary embodiments discussed herein. In one or more embodiments, data processing device 100 may include a processor 102 (e.g., a Central Processing Unit (CPU), a Graphics Processing Unit (GPU)) communicatively coupled to a memory 104 (e.g., a volatile memory and/or a non-volatile memory); memory 104 may include storage locations configured to be addressable through processor 102.

In one or more embodiments, data processing device 100 may be either wirelessly coupled to target display 106 or coupled thereto through wired means. Examples of wireless coupling may include Wi-Fi™ based coupling and Bluetooth® based coupling. Examples of wired coupling may include High-Definition Multimedia Interface (HDMI) based coupling and Universal Serial Bus (USB) based coupling. Other forms of wired and/or wireless coupling are within the scope of the exemplary embodiments discussed herein.

In one or more embodiments, data processing device 100 may include a display 110 (again, examples include an LCD and a CRT monitor); display 110 is shown in FIG. 1 as being interfaced with processor 102. It should be noted that display 110 and/or target display 106 may be interfaced with processor 102 through appropriate display interfaces (not shown in the case of display 110; display interface 168 in the case of target display 106). In one or more embodiments, output data processed by processor 102 may be input to a multimedia processing unit (not shown) configured to perform encoding/decoding associated with the data. In one or more embodiments, the output of the multimedia processing unit may be rendered on display 110. Display 110 may be regarded as an internal display of data processing device 100 and target display 106 may be regarded as a display external thereto. Target display 106 may have enhanced capabilities associated therewith when compared to display 110. For example, target display 106 may have larger dimension(s) associated therewith, may provide for superior/enhanced display attributes, may support a higher range of display attributes and the like.

In one or more embodiments, a user 150 of data processing device 100 may receive video phone call 142 from another data processing device 152 (e.g., a mobile phone) communicatively coupled thereto through a network 108 (example mobile network). In one or more embodiments, an operating system 112 may execute on data processing device 100; FIG. 1 shows operating system 112 as being stored in memory 104. Operating system 112 may be configured to generate an event notification with regard to video phone call 142. For example, video phone call 142 may generate an interrupt to operating system 112, which handles said interrupt through one or more interrupt handlers. In one or more embodiments, processor 102 may detect video phone call 142 based on the event notification generated by operating system 112. Other forms of detection of video phone call 142 are within the scope of the exemplary embodiments discussed herein.

In one or more embodiments, upon detection of video phone call 142, processor 102 may be configured to transmit display data (e.g., display data 186 shown in memory 104) associated with display 110 to target display 106. In one or more embodiments, the transmission of display data 186 may involve mirroring of display data 186 on display 110 across target display 106; alternately, display data 186 may solely be rendered on target display 106. In one or more embodiments, the transmission/mirroring of display data 186 may occur for a duration of video phone call 142.

In one or more embodiments, processor 102 may be configured to poll target display 106 for a list of display attributes (e.g., a resolution range) supported therein. In one or more embodiments, upon acquisition of the list of display attributes supported by target display 106, processor 102 may be configured to scale one or more display attributes of display data 186 to suit appropriate rendering thereof on target display 106. Alternately, in one or more embodiment, target display 106 may be provided with intelligence such that the aforementioned scaling may be performed therein. Here, processor 102 may transmit display data 186 as is, which, then, may be scaled at target display 106. FIG. 1 shows target display 106 with processor 162 and memory 164 therefor.

It should be noted that processor 102 may be configured to transmit/mirror display data 186 upon mere detection of incoming video phone call 142. Alternately, processor 102 may be configured to transmit/mirror display data 186 only upon establishment of a phone connection between data processing device 100 and data processing device 152. All variations are within the scope of the exemplary embodiments discussed herein.

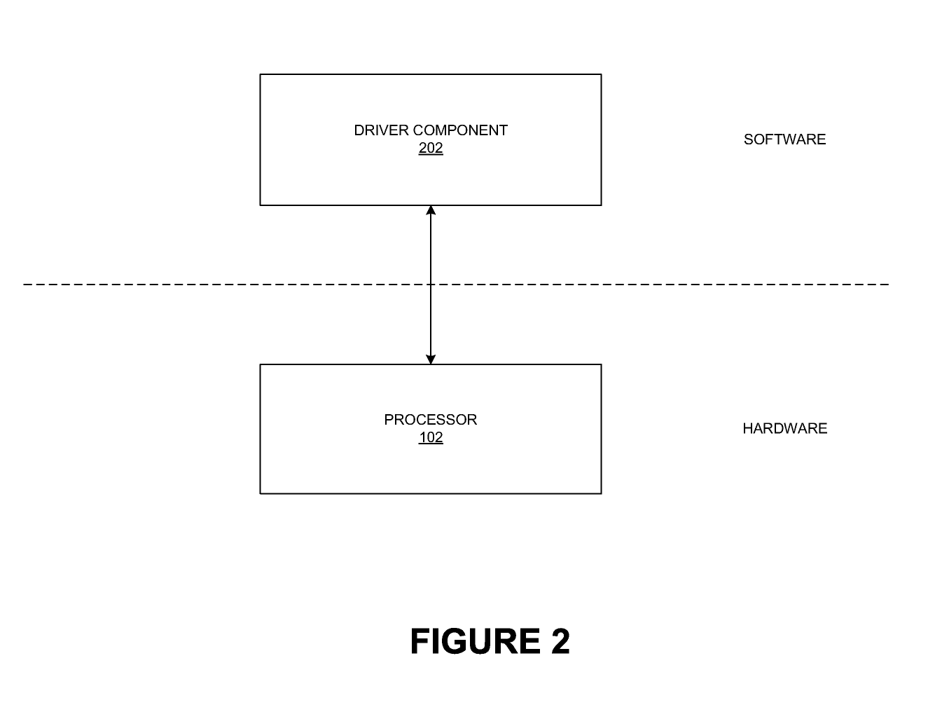

In one or more embodiments, the abovementioned detection of video phone call 142 and/or the transmission/mirroring of display data 186 to/across target display 106 may be initiated through a driver component (e.g., a set of instructions) associated with processor 102. FIG. 2 shows interaction between a driver component 202 and processor 102; alternately, driver component 202 may be associated with display 110 and/or target display 106. Driver component 202 may include instructions to initiate the detection of video phone call 142 and/or the transmission/mirroring of display data 186 to/across target display 106. Driver component 202 may be packaged with operating system 112 and/.or an application (e.g., application 188 shown as being stored in memory 104 in FIG. 1) executing on data processing device 100.

Instructions associated with driver component 202 may also be embodied on a non-transitory medium (e.g., Compact Disc (CD), Digital Video Disc (DVD), hard drive; appropriate instructions may be downloaded to the hard drive) readable through data processing device 100. Variations therein are within the scope of the exemplary embodiments discussed herein.

Thus, in one or more embodiments, user 150 may be provided a capability to leverage an enhanced capability of target display 106 while handling video phone call 142. Also, in one or more embodiments, target display 106 may possess an enhanced camera capability therein. FIG. 1 shows a video camera 194 associated with target display 106; video camera 194 is shown as being interfaced with processor 162. Said video camera 194 may offer enhanced capabilities to capture a video/image of user 150 when compared to a video camera (not shown) of data processing device 100. Thus, exemplary embodiments may even benefit a user originating video phone call 142; he/she may be able to view better videos/video frames/images of user 150 on data processing device 152.

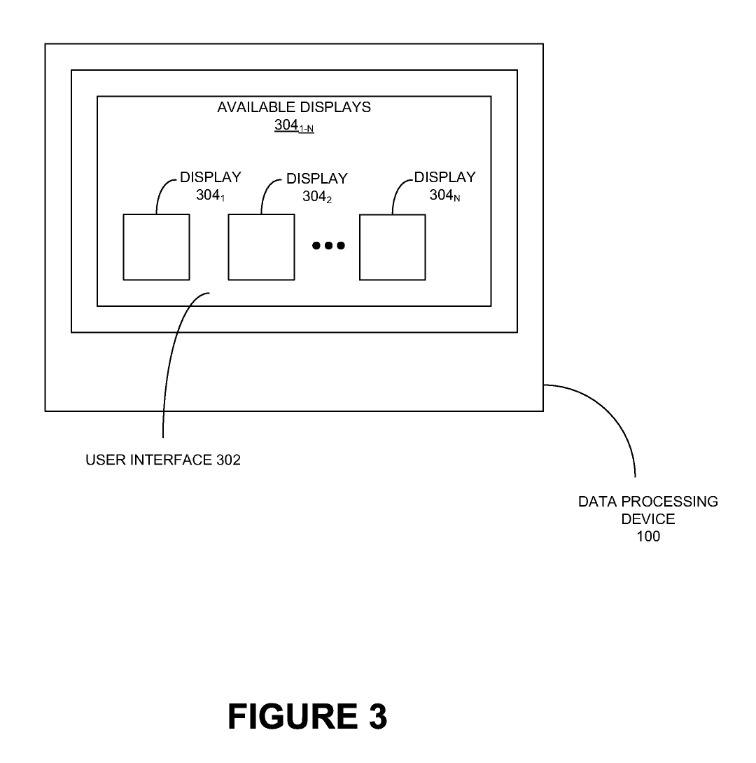

FIG. 3 shows a user interface 302 of data processing device 100; an example user interface 302 may be a touchscreen. In an example case of data processing device 100 being wirelessly coupled to target display 106, user interface 302 may enable detection of a list of available displays 304_{1-N}, from which user 150 is able to select target display 106.

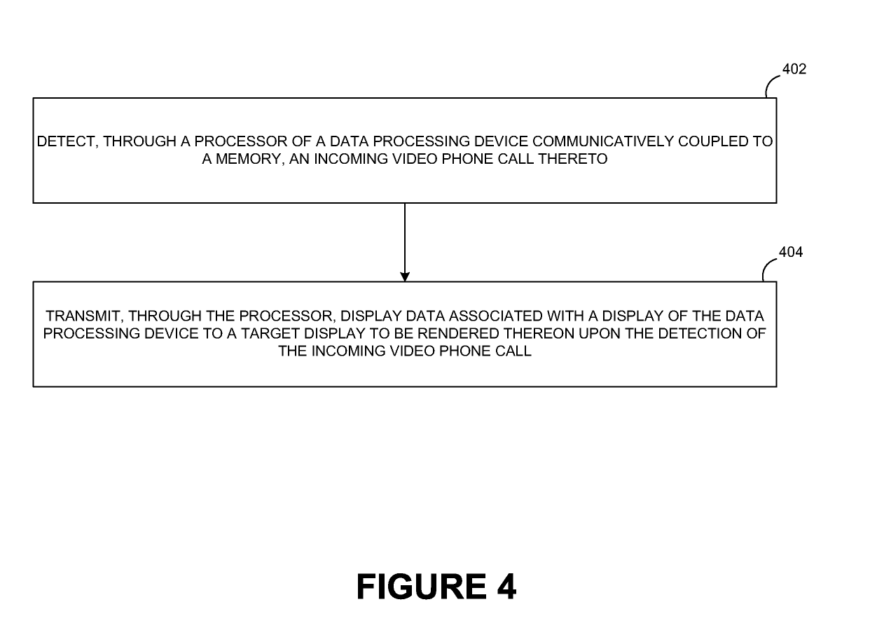

FIG. 4 shows a process flow diagram detailing the operations involved in display data transmission to an external display (e.g., target display 106) of data processing device 100 to enhance a video phone call (e.g., video phone call 142) experience therethrough, according to one or more embodiments. In one or more embodiments, operation 402 may involve detecting, through processor 102 of data processing device 100 communicatively coupled to memory 104, an incoming video phone call 142 thereto. In one or more embodiments, operation 404 may then involve transmitting, through processor 102, display data 186 associated with display 110 of data processing device 100 to target display 106 to be rendered thereon upon the detection of incoming video phone call 142. In one or more embodiments, target display 106 may be external to data processing device 100 and communicatively coupled thereto.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., data processing device 100). Accordingly, the specification and drawings are to be regarded in an illustrative rather than a restrictive sense.

What is claimed is:

1. A method to enhance a video call experience on a data processing device, comprising:
detecting, through a processor of the data processing device communicatively coupled to a memory, an incoming video phone call thereto; and
transmitting, through the processor, display data associated with a display of the data processing device to a target display to be rendered thereon upon the detection of the incoming video phone call, the target display being external to the data processing device and communicatively coupled thereto.

2. The method of claim 1, further comprising generating an event notification to the processor of the incoming video phone call through an operating system executing on the data processing device to enable the detection of the incoming video phone call.

3. The method of claim 1, comprising transmitting the display data associated with the display to the target display upon establishment of a phone connection between the data processing device and another data processing device originating the video phone call.

4. The method of claim 1, further comprising at least one of:
obtaining, through the processor, a list of supported display attributes on the target display; and
at least one of: scaling the display data through the processor and scaling the transmitted display data through a processor of the target display in accordance with the list of supported display attributes to provide compatibility with the target display.

5. The method of claim 1, comprising one of: wirelessly coupling the target display to the data processing device and coupling the target display to the data processing device through wired means.

6. The method of claim 1, comprising at least one of:
providing a display having an enhanced display capability compared to the display of the data processing device as the target display;
providing a capability to capture at least one of a video and an image of a user of the data processing device through a video camera associated therewith for utilization during the video phone call; and
providing, through a user interface of the data processing device, a capability to the user to select the target display from a list of available displays when the data processing device is configured to be wirelessly coupled to the target display.

7. The method of claim 1, further comprising initiating the detection of the incoming video phone call and the transmission of the display data through a driver component provided in the data processing device.

8. A non-transitory medium, readable through a data processing device and including instructions embodied therein that are executable through the data processing device, comprising:
instructions to detect, through a processor of the data processing device communicatively coupled to a memory, an incoming video phone call thereto; and
instructions to transmit, through the processor, display data associated with a display of the data processing device to a target display to be rendered thereon upon the detection of the incoming video phone call, the target display being external to the data processing device and communicatively coupled thereto.

9. The non-transitory medium of claim 8, further comprising instructions to generate an event notification to the processor of the incoming video phone call through an operating system executing on the data processing device to enable the detection of the incoming video phone call.

10. The non-transitory medium of claim 8, comprising instructions to transmit the display data associated with the display to the target display upon establishment of a phone connection between the data processing device and another data processing device originating the video phone call.

11. The non-transitory medium of claim 8, further comprising at least one of:
instructions to obtain, through the processor, a list of supported display attributes on the target display; and
instructions to at least one of: scale the display data through the processor and scale the transmitted display data through a processor of the target display in accordance with the list of supported display attributes to provide compatibility with the target display.

12. The non-transitory medium of claim 8, comprising instructions compatible with one of: wirelessly coupling the target display to the data processing device and coupling the target display to the data processing device through wired means.

13. The non-transitory medium of claim 8, comprising at least one of:
instructions to provide a display having an enhanced display capability compared to the display of the data processing device as the target display;
instructions to provide a capability to capture at least one of a video and an image of a user of the data processing device through a video camera associated therewith for utilization during the video phone call; and
instructions to provide, through a user interface of the data processing device, a capability to the user to select the target display from a list of available displays when the data processing device is configured to be wirelessly coupled to the target display.

14. A system comprising:
a data processing device comprising a memory, a processor communicatively coupled to the memory and a display; and
a target display external to the data processing device and configured to be communicatively coupled thereto, the processor of the data processing device being configured to execute instructions to detect an incoming video phone call thereto and to transmit display data associated with the display of the data processing device to the target display to be rendered thereon upon the detection of the incoming video phone call.

15. The system of claim 14, wherein the data processing device executes an operating system thereon configured to generate an event notification to the processor of the incoming video phone call to enable the detection of the incoming video phone call.

16. The system of claim 14, wherein the processor of the data processing device is configured to execute instructions to transmit the display data associated with the display to the target display upon establishment of a phone connection between the data processing device and a data processing device originating the video phone call.

17. The system of claim 14,
wherein the processor of the data processing device is configured to execute instructions to obtain a list of supported display attributes on the target display, and
wherein at least one of: the processor of the data processing device and a processor of the target display is configured to execute instructions to scale the display data in accordance with the list of supported display attributes to provide compatibility with the target display.

18. The system of claim 14, wherein the target display is one of: wirelessly coupled to the data processing device and coupled to the data processing device through wired means.

19. The system of claim 14, wherein at least one of:
the target display provides for enhanced display capability compared to the display of the data processing device,
the data processing device is provided with a capability to capture at least one of a video and an image of a user thereof through a video camera associated therewith for utilization during the video phone call, and
the data processing device is configured to provide, through a user interface thereof, a capability to the user to select the target display from a list of available displays when the data processing device is configured to be wirelessly coupled to the target display.

20. The system of claim 14, wherein the data processing device further comprises a driver component to initiate the detection of the incoming video phone call and the transmission of the display data.
